(19) United States
(12) Patent Application Publication
(10) Pub. No.: US 2012/0217825 A1
(43) Pub. Date: Aug. 30, 2012

(54) VEHICLE DRIVE SYSTEM

(75) Inventors: Satoru KASUYA, Nishio (JP); Masashi KITO, Anjo (JP); Shigeru SUGISAKA, Nishio (JP); Hideyuki MORI, Okazaki (JP)

(73) Assignee: AISIN AW CO., LTD., Anjo-shi (JP)

(21) Appl. No.: 13/353,692

(22) Filed: Jan. 19, 2012

(30) Foreign Application Priority Data
Feb. 28, 2011 (JP) 2011-042101

(51) Int. Cl. H02K 9/193

(52) U.S. Cl. 310/54

(57) ABSTRACT

A vehicle drive system includes a rotor support that is more radially inward than the stator and supports the rotor; a supply that supplies oil to the rotor support bearing, the rotor support bearing includes a discharge that discharges oil supplied from the supply, the rotor support includes an opposing surface that opposes the discharge-side surface, and an opposing extension surface that extends radially from the opposing surface. The stator includes a coil end that protrudes from the stator core toward the first axial direction. A radial outer end of the opposing extension surface is more radially inward than, and overlaps with, the coil end, with a radial space between the radial outer end and the coil end. The discharge-side surface is disposed more toward the second axial direction than the radial outer end of the opposing extension surface.

### INCORPORATION BY REFERENCE

The disclosure of Japanese Patent Application No. 2011-042101 filed on Feb. 28, 2011 including the specification, drawings and abstract is incorporated herein by reference in its entirety.

### BACKGROUND OF THE INVENTION

The present invention relates to a vehicle drive system that includes, as a drive power source of a vehicle, a rotating electric machine that has a rotor and a stator.

### Description of the Related Art

Art such as that disclosed in WO 2005/105507 Pamphlet below relates to the vehicle drive system described above. In the vehicle drive system according to WO 2005/105507, a case (motor housing 4) includes a radially extending support wall (partition member 50) on one side of the axial direction of a rotating electric machine (motor generator 2), and a rotor support member (rotor support plate 41 and front cover 24) that rotatably supports a rotor (40). A rotor support bearing (bearing 55) is disposed between the support wall and the rotor support member, and rotatably supports the rotor support member with respect to the support wall. Also, in the vehicle drive system according to WO 2005/105507, an input shaft support bearing (bearing 70) is disposed between the rotor support member and an input shaft (center member 31, connection member 30), and rotatably supports the input shaft with respect to the rotor support member.

According to the art in WO 2005/105507, the rotor support member is configured so as to also function as a cover body that accommodates a clutch therein, and formed such that oil is supplied to inside the cover body. The oil inside the cover body is further supplied to the input shaft support bearing.

However, the art in WO 2005/105507 uses a configuration in which oil is not supplied from outside to the rotor support bearing, and the type of bearing that can be used as the rotor support bearing is limited to one with lubrication oil sealed therein or the like. Moreover, WO 2005/105507 does not describe a technique for cooling a coil of a stator using the oil. The art in WO 2005/105507 is incapable of effectively utilizing the oil inside the cover body, for example, to cool the stator coil.

### SUMMARY OF THE INVENTION

In view of the foregoing, a vehicle drive system is desired that can supply oil to a rotor support bearing from outside, and cool a coil of a stator using the oil.

A vehicle drive system according to a first aspect of the present invention includes, as a drive power source of a vehicle, a rotating electric machine that has a rotor and a stator. The vehicle drive system further includes: a case that accommodates the rotating electric machine, and includes an at least radially extending support wall on a first axial direction side, the first axial direction side being one axial direction side with respect to the rotating electric machine; a rotor support member that is more radially inward than the stator and supports the rotor; a rotor support bearing that supports the rotor support member as rotatable with respect to the support wall; and a supply portion that supplies oil to the rotor support bearing. Further, a side opposite from the first axial direction side in the axial direction is a second axial direction side. The rotor support bearing includes, on a discharge-side surface that is a surface of the rotor support bearing on the second axial direction side, a discharge portion that discharges the oil supplied from the supply portion. The rotor support member includes an opposing surface portion that is more toward the second axial direction side than the discharge-side surface and opposes the discharge-side surface, and an opposing extension surface portion that extends radially outward from the opposing surface portion. The stator includes a stator core, and a coil end portion that protrudes from the stator core toward the first axial direction side. A radial outer end portion of the opposing extension surface portion is disposed at a position that is more radially inward than the coil end portion, and overlaps with the coil end portion as viewed from the radial direction, with a radial space interposed between the radial outer end portion and the coil end portion. The discharge-side surface is disposed more toward the second axial direction side than the radial outer end portion of the opposing extension surface portion. Lastly, the opposing extension surface portion is formed such that a radial cross section from a radial inner end portion of the opposing extension surface portion to the radial outer end portion extends only in one or both of a direction heading radially outward and a direction heading toward the first axial direction side.

In the present application, “overlapping as viewed from a predetermined direction” with respect to the arrangement of two members indicates that, when using the predetermined direction as a line of sight and moving a viewpoint to each direction perpendicular to that line of sight, there exists a viewpoint at which the two members appear to overlap in at least some regions.

According to the first aspect of the present invention, the oil discharged from the discharge portion of the rotor support bearing is supplied to the opposing surface portion of the rotor support member, which is disposed facing the discharge-side surface. The oil supplied to the opposing surface portion of the rotor support member is subjected to a centrifugal force due to the rotation of the rotor support member, whereby the oil flows from the opposing surface portion toward the opposing extension surface portion that extends radially outward.

According to the first aspect of the present invention, the opposing extension surface portion is formed such that from the radial inner end portion to the radial outer end portion of the opposing extension surface portion extends in one or both of a direction heading radially inward and a direction heading toward the axial first direction side. Thus, the centrifugal force that acts on the oil becomes, on the opposing extension surface portion, one or both of a force heading toward the opposing extension surface portion, and a force in a direction heading radially outward along the opposing extension surface portion. Accordingly, the oil on the opposing extension surface portion does not separate from the opposing extension surface portion, and flows to the radial outer end portion along the opposing extension surface portion.

The oil that flows to the radial outer end portion of the opposing extension surface portion separates from the radial outer end portion and scatters radially outward due to the centrifugal force heading radially outward. According to the first aspect of the present invention, the coil end portion is disposed with the space interposed between the coil end portion and the radial outer end portion in a direction heading radially outward from the radial outer end portion of the opposing extension surface portion. Therefore, the oil scattered radially outward from the radial outer end portion is supplied to the coil end portion. At such time, because the rotor support member is rotating, the oil is supplied over the entire circumference of the coil end portion. Thus, the entire circumference of the coil end portion can be cooled.

According to a second aspect of the present invention, the support wall may include a support wall surface portion that is more toward the first axial direction side than the opposing extension surface portion, faces the opposing extension surface portion, and extends in the radial direction. The support wall surface portion may include a projection portion that is more downward than the discharge portion, protrudes toward the second axial direction side, and extends in a direction intersecting the vertical direction along the support wall surface portion. A portion of the opposing extension surface portion may be disposed at a position that is downward of a lowermost portion of an end portion of the projection portion on the second axial direction side, and overlaps with the lowermost portion as viewed from the vertical direction, and the lowermost portion may be disposed with a vertical space interposed between the lowermost portion and the portion of the opposing extension surface portion.

According to the second aspect of the present invention, the oil discharged from the discharge portion of the rotor support bearing also flows along the support wall surface portion, which faces the discharge-side surface and radially extends.

The oil that flows downward along the support wall surface portion due to gravity is blocked by the projection portion that protrudes toward the axial second direction side, and extends in a direction intersecting the vertical direction along the support wall surface portion. The blocked oil then flows along an upper surface of the projection portion toward the lowermost portion of the end portion of the projection portion on the second axial direction side due to gravity and surface tension, and drips downward due to gravity.

According to the second aspect of the present invention, the opposing extension surface portion of the rotor support member is disposed in a direction heading downward from the lowermost portion, with the space interposed between the opposing extension surface portion and the lowermost portion. Thus, the oil dripping downward from the lowermost portion of the projection portion is supplied to the opposing extension surface portion.

Also, because the opposing extension surface portion is rotating with respect to the support wall surface portion, the oil that drips downward from the lowermost portion of the projection portion is supplied over the entire circumference of the opposing extension surface portion. As described above, the oil supplied to the opposing extension surface portion then flows along the opposing extension surface portion to the radial outer end portion due to the centrifugal force heading radially outward, and is supplied over the entire circumference of the coil end portion from the radial outer end portion.

According to a third aspect of the present invention, the projection portion may be formed so as to extend over an entire area overlapping with the discharge portion based on a positional relationship in a direction perpendicular to both the axial direction and the vertical direction.

According to the third aspect of the present invention, the oil that flows downward from each section of the discharge portion along the support wall surface portion can be reliably blocked by the projection portion and flow toward the opposing extension surface portion of the rotor support member.

According to a fourth aspect of the present invention, the opposing extension surface portion may include an inclined surface portion that extends more toward the first axial direction side as the inclined surface portion extends radially outward. In addition, a portion of the inclined surface portion may be disposed at a position that is downward of the lowermost portion of the end portion of the projection portion on the axial second direction side, and overlaps with the lowermost portion as viewed from the vertical direction, and the lowermost portion may be disposed with a vertical space interposed between the lowermost portion and the portion of the inclined surface portion.

According to the fourth aspect of the present invention, the oil dripping downward from the lowermost portion of the end portion of the projection portion is supplied to the inclined surface portion of the opposing extension surface portion. A force (force vector) heading radially outward that is caused by centrifugal force and acts on the oil on the inclined surface portion is broken down on the inclined surface portion facing radially inward and toward the axial first direction side into a component heading toward the inclined surface portion, and a component heading radially outward along the inclined surface portion. Accordingly, the supplied oil on the opposing extension surface portion starts to flow radially outward after being supplied, and smoothly flows to the radial outer end portion.

According to a fifth aspect of the present invention, the support wall may include a support wall surface portion that is more toward the first axial direction side than the opposing extension surface portion, faces the opposing extension surface portion, and extends in the radial direction. The support wall surface portion may include a stepped portion that has a stepped surface facing radially outward. In addition, an end portion of the stepped surface on the second axial direction side may be disposed at a position that is more radially inward than the coil end portion, and overlaps with the coil end portion as viewed from the radial direction, with a radial space interposed between the end portion and the coil end portion.

The oil not supplied to the opposing extension surface portion from the discharge portion flows along the support wall surface portion. According to the fifth aspect of the present invention, the oil flowing downward along the support wall surface portion due to gravity reaches the stepped portion. Such oil drips downward from the end portion of the stepped surface on the axial second direction side due to gravity.

The rotation shaft center of the rotating electric machine may be horizontally disposed or disposed at a nearly horizontal angle. In such cases, according to the fifth aspect of the present invention, the coil end portion is disposed in a direction heading downward from each part of the end portion of the stepped surface on the second axial direction side, with a space interposed between the coil end portion and the end portion. Thus, the oil dripping from the end portion of the stepped surface is supplied to the coil end portion. Accordingly, the oil not supplied to the opposing extension surface portion is also supplied to the coil end portion by the stepped portion included in the support wall surface portion, and can be utilized to cool the coil end portion.

According to a sixth aspect of the present invention, the stepped surface may be one of a surface parallel to the axial direction, and a surface that extends more radially inward as the surface extends toward the first axial direction side.

If the rotation shaft center of the rotor is horizontally disposed or disposed at a nearly horizontal angle, and the stepped surface is one of a surface parallel to the axial direction, and a surface that extends more radially inward as the surface extends toward the first axial direction side, a force (force vector) that is caused by gravity and acts on the oil on the stepped surface does not break down on the stepped surface into a component heading toward the first axial direction side. Therefore, it is possible to suppress the flow of oil along the stepped surface toward the first axial direction side. Accordingly, the oil can drip from the end portion of the stepped surface on the second axial direction side onto the coil end portion.

According to a seventh aspect of the present invention, the discharge-side surface may be disposed at a position overlapping with the stator core as viewed from the radial direction.

According to the seventh aspect of the present invention, the rotor support bearing is disposed so as to at least partially overlap with the stator core and the rotor core as viewed from the radial direction. Thus, a space more radially inward than the rotor can be effectively utilized to dispose the rotor support bearing, and the axial length of the vehicle drive system can be easily shortened. In addition, according to the present invention, the radial cross section from the radial inner end portion to the radial outer end portion of the opposing extension surface portion is formed so as to extend only in one or both of a direction heading radially outward and a direction heading toward the first axial direction side. Therefore, even with such a configuration, the oil discharged from the discharge-side surface can appropriately flow radially outward and toward the first axial direction side, and be supplied to the coil end portion that extends from the stator core toward the first axial direction side.

According to an eighth aspect of the present invention, a rotation sensor that detects the rotation of the rotor may be provided, wherein the rotation sensor is disposed at a position on the second axial direction side with respect to the rotor support member.

According to the eighth aspect of the present invention, the rotation sensor is not disposed on the first axial direction side of the rotor support member on which the opposing extension surface portion is formed. It is therefore possible to prevent the rotation sensor from interfering with the flow of oil that flows on the opposing extension surface portion, and a smooth oil flow can be achieved.

### BRIEF DESCRIPTION OF THE DRAWINGS

FIG. 1 is a schematic diagram that shows the overall configuration of a vehicle drive system according to an embodiment of the present invention;

FIG. 2 is a partial cross-sectional view of the vehicle drive system according to the embodiment of the present invention;

FIG. 3 is a cross-sectional view of an essential portion of the vehicle drive system according to the embodiment of the present invention;

FIG. 4 is a plane view of an essential portion of the vehicle drive system according to the embodiment of the present invention; and

FIG. 5 is a cross-sectional view of an essential portion of the vehicle drive system according to another embodiment of the present invention.

### DETAILED DESCRIPTION OF THE EMBODIMENTS

### 1. First Embodiment

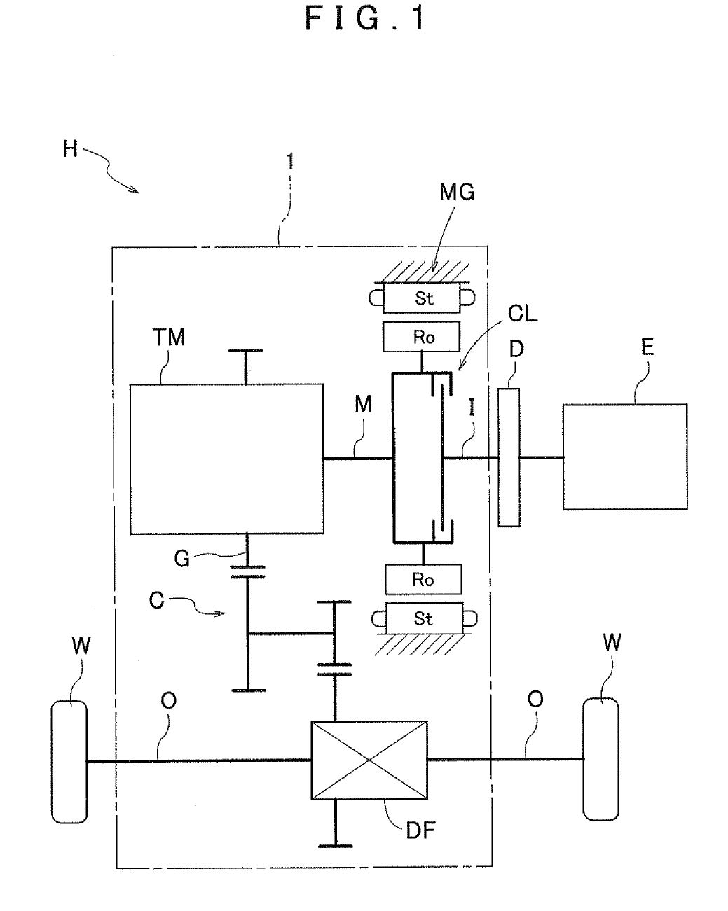

An embodiment of the present invention will be described with reference to the drawings. In the present embodiment, a vehicle drive system according to the present invention is applied as a hybrid drive system as an example. FIG. 1 is a schematic diagram that shows the overall configuration of a hybrid drive system H according to the present embodiment. The hybrid drive system H is a drive system for a hybrid vehicle that uses one or both of an internal combustion engine E and a rotating electric machine MG as a drive power source of the vehicle. The hybrid drive system H is configured as a so-called one-motor parallel type of hybrid drive system. The hybrid drive system H according to the present embodiment will be described in detail below.

### 1-1. Overall Configuration of Hybrid Drive System

First, the overall configuration of the hybrid drive system H according to the present embodiment will be described. As shown in FIG. 1, the hybrid drive system H includes an input shaft I that is drive-coupled to the internal combustion engine E that serves as a first drive power source of the vehicle; the rotating electric machine MG that serves as a second drive power source of the vehicle; a speed change mechanism TM; an intermediate shaft M that is drive-coupled to the rotating electric machine MG and drive-coupled to the speed change mechanism TM; and an output shaft O that is drive-coupled to a wheel W. The hybrid drive system H further includes a clutch CL that is provided capable of switching between transmitting and not transmitting drive power between the input shaft I and the intermediate shaft M; a counter gear mechanism C; and an output differential gear device DF. Each of these configurations is accommodated inside a case (drive system case) 1.

It should be noted that “drive-coupled” refers to a state in which two rotation elements are connected capable of transmitting drive power, and is used as an idea that includes a state in which the two rotation elements are coupled so as to rotate together, or a state in which the two rotation elements are coupled capable of transmitting drive power through one, two, or more transmission members. Such transmission members include various types of members that transmit rotation at the same speed or a changed speed, and include a shaft, a gear mechanism, a belt, and a chain, for example. In addition, “drive power” is used synonymous with torque. Also, in the present embodiment, the axial direction, the radial direction, and the circumferential direction are each specified using the rotation shaft centers of the coaxially disposed input shaft I, intermediate shaft M, and rotating electric machine MG as a reference. Moreover, “up” indicates vertically upward in a vehicle mounted state where the hybrid drive system H is mounted in the vehicle, and “down” indicates vertically downward in the vehicle mounted state.

The internal combustion engine E is a device that is driven by the combustion of fuel therein to extract power, and various types of commonly known engines such as a gasoline engine and a diesel engine may be used, for example. In the present example, an output rotation shaft such as a crankshaft of the internal combustion engine E is drive-coupled to the input shaft I through a damper D. The input shaft I is drive-coupled to the rotating electric machine MG and the intermediate shaft M through the clutch CL. Using the clutch CL, the input shaft I is selectively drive-coupled to the rotating electric machine MG and the intermediate shaft M. During the engaged state of the clutch CL (connected state of two engagement members that are engaged by the clutch CL), the internal combustion engine E and the rotating electric machine MG are drive-coupled through the input shaft I. During the disengaged state of the clutch CL (disconnected state of the two engagement members), the internal combustion engine E and the electric rotating machine MG are separated (the connection between the internal combustion engine E and the electric rotating machine MG is canceled).

The rotating electric machine MG is configured to include a stator St and a rotor Ro. The rotating electric machine MG can function as a motor (electric motor) that receives a supply of electric power to generate motive power, and also function as a generator (electric generator) that receives a supply of motive power to generate electric power. Therefore, the rotating electric machine MG is electrically connected to an electric storage device (not shown). In the present example, a battery is used as the electric storage device. Note that a capacitor or the like is also well suited for use as the electric storage device. The rotating electric machine MG receives a supply of electric power from the battery for power running, and supplies electric power generated by the inertial force of the vehicle or torque output by the internal combustion engine E to the battery to accumulate electric power in the battery. The rotor Ro of the rotating electric machine MG is drive-coupled to the intermediate shaft M so as to rotate together with the intermediate shaft M. The intermediate shaft M is an input shaft (speed change input shaft) of the speed change mechanism TM.

The speed change mechanism TM is a device that changes a rotational speed of the intermediate shaft M by a predetermined speed ratio and transmits the changed rotational speed to a speed change output gear G. As the speed change mechanism TM described above, the present embodiment uses an automatic stepped speed change mechanism that is configured to include single pinion type and Ravigneaux type planetary gear mechanisms, as well as a plurality of engagement devices such as a clutch, a brake, and a one-way clutch. This speed change mechanism also includes and can switch between a plurality of shift speeds with different speed ratios. Note that the following may also be used as the speed change mechanism TM: an automatic stepped speed change mechanism that includes other specific configurations; an automatic continuously variable speed change mechanism that can steplessly change the speed ratio; and a manual stepped speed change mechanism that includes and can switch between a plurality of shift speeds with different speed ratios. The speed change mechanism TM changes the rotational speed of the intermediate shaft M by a predetermined speed ratio at that particular time and converts the torque, which the speed change mechanism TM then transmits to the speed change output gear G.

The speed change output gear G is drive-coupled to the output differential gear device DF through the counter gear mechanism C. The output differential gear device DF is drive-coupled to the wheel W through the output shaft O, and distributes and transmits the rotation and torque input to the output differential gear device DF to two left and right wheels W. Thus, the hybrid drive system H can run the vehicle by transmitting the torque of one or both of the internal combustion engine E and the rotating electric machine MG to the wheel W.

It should be noted that the hybrid drive system H according to the present embodiment is configured with a plurality of axes such that the input shaft I and the intermediate shaft M are coaxially disposed, and the output shaft O is disposed on a different axis parallel to the input shaft I and the intermediate shaft M. The configuration described above is suitable as the configuration of the hybrid drive system H mounted in a front engine, front wheel drive (FF) vehicle, for example.

### 1-2. Configuration of Various Parts of Hybrid Drive System

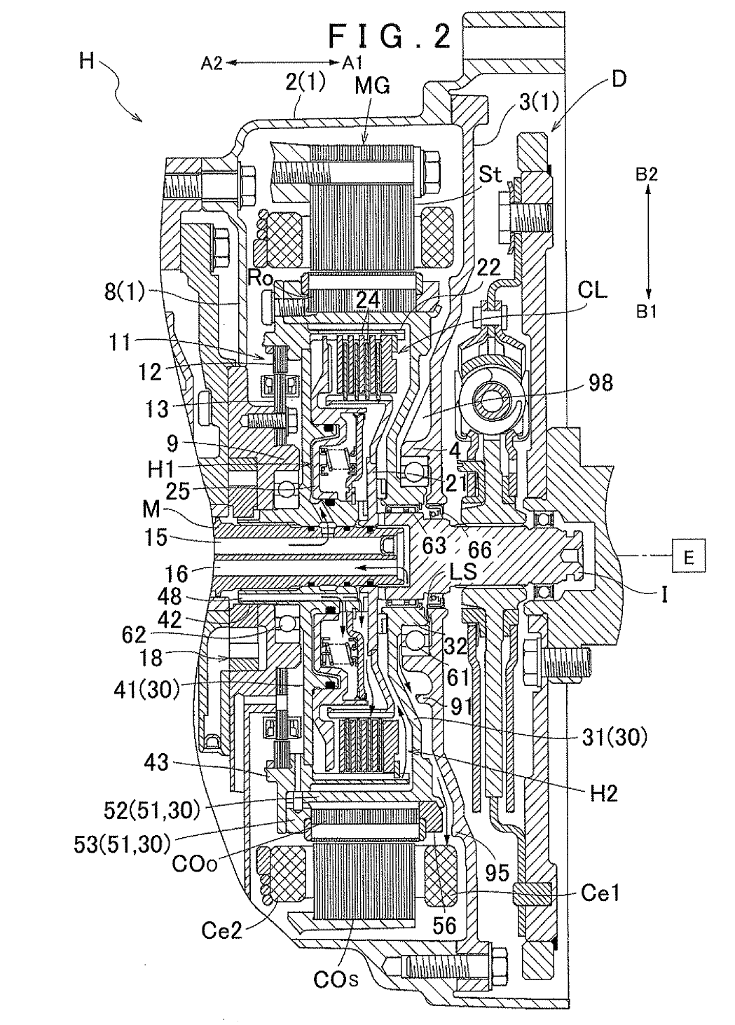

Next, the configuration of various parts of the hybrid drive system H according to the present embodiment will be described. As shown in FIG. 2, a case 1 accommodates at least the rotating electric machine MG and the clutch CL. The case 1 includes a case peripheral wall 2 that covers an outer periphery of accommodated sections of the rotating electric machine MG, the speed change mechanism TM, and the like; a first support wall 3 that is on a first axial direction A1 side (the right side in FIG. 2, which is also the internal combustion engine E side; likewise hereafter), and blocks an opening of the case peripheral wall 2; and a second support wall 8 that is more toward a second axial direction A2 side (the left side in FIG. 2, which is the opposite side from the internal combustion engine E; likewise hereafter) than the first support wall 3, and disposed between the rotating electric machine MG and the speed change mechanism TM in the axial direction. Note that the first support wall 3 corresponds to a “support wall” of the present invention.

The first support wall 3 has a shape that at least extends in the radial direction; in the present embodiment, the first support wall 3 extends in the radial direction and the circumferential direction. The first support wall 3 is formed with an axial through hole. The input shaft I inserted into the through hole runs through the first support wall 3 and is inserted into the case 1. The first support wall 3 includes an axial protruding portion 4 with a cylindrical shape (boss shape) that protrudes toward the second axial direction A2 side. The first support wall 3 is disposed on the first axial direction A1 side with respect to the rotating electric machine MG and the clutch CL. More specifically, the first support wall 3 is disposed next to a rotor support member 30, which supports the rotor Ro of the rotating electric machine MG, on the first axial direction A1 side with a predetermined space between the first support wall 3 and the rotor support member 30. In addition, the first support wall 3 rotatably supports the rotor support member 30 on the first axial direction Al side of the rotating electric machine MG.

The second support wall 8 has a shape that at least extends in the radial direction; in the present embodiment, the second support wall 8 extends in the radial direction and the circumferential direction. The second support wall 8 is formed with an axial through hole. The intermediate shaft M inserted into the through hole runs through the second support wall 8. The second support wall 8 is connected to an axial protruding portion 9 with a cylindrical shape (boss shape) that protrudes toward the first axial direction A1 side. The axial protruding portion 9 is integratedly connected to the second support wall 8. The second support wall 8 is disposed on the second axial direction A2 side with respect to the rotating electric machine MG and the clutch CL. More specifically, the second support wall 8 is disposed next to the rotor support member 30 on the second axial direction A2 side with a predetermined space between the second support wall 8 and the rotor support member 30. In addition, the second support wall 8 rotatably supports the rotor support member 30 on the second axial direction A2 side of the rotating electric machine MG. A sensor stator 13 of a rotation sensor (resolver) 11 is also fixed to a radial outer side of the axial protruding portion 9.

A pump chamber formed inside the second support wall 8 accommodates an oil pump 18. In the present embodiment, the oil pump 18 is an internal gear pump that has an inner rotor and an outer rotor. The inner rotor of the oil pump 18 has a radial center portion that is spline-connected to the rotor support member 30 such that the inner rotor rotates together with the rotor support member 30. The oil pump 18 suctions oil from an oil pan (not shown) as a result of rotation of the rotor support member 30, and discharges the suctioned oil such that the oil is supplied to the clutch CL, the speed change mechanism TM, the rotating electric machine MG, and the like. It should be noted that oil passages are respectively formed inside the second support wall 8 and the intermediate shaft M. The oil discharged from the oil pump 18 is supplied through the oil passages and a hydraulic control device not shown in the drawings to various regions that require a supply of oil. The oil supplied to the various regions performs one or both of lubricating and cooling the regions. The oil in the present embodiment functions as a “lubricating-cooling fluid” that can function as both a lubricating fluid and a cooling fluid.

The input shaft I is a shaft member used to input the torque of the internal combustion engine E to the hybrid drive system H. The input shaft I has an end portion on the first axial direction A1 side that is drive-coupled to the internal combustion engine E. The input shaft I is provided as running through the first support wall 3, and as shown in FIG. 2, is drive-coupled on the first axial direction A1 side of the support wall 3 to an output rotation shaft of the internal combustion engine E through the damper D so as to rotate together with the output rotation shaft. In addition, a seal member 66 is provided that secures an oil-tight state between an outer peripheral surface of the input shaft I and an inner peripheral surface of the through hole provided in the first support wall 3 to suppress oil leakage to the first axial direction A1 side (damper D side).

In the present embodiment, a radial center portion of an end portion of the input shaft I on the second axial direction A2 side is formed with a hole portion that extends in the axial direction. The intermediate shaft M, which is disposed coaxial with the input shaft I, has an end portion on the first axial direction A1 side that fits into the hole portion. The end portion of the input shaft I on the second axial direction A2 side is connected to a clutch hub 21 that extends radially outward. In the present embodiment, the rotor support member 30 is formed so as to cover a surrounding area of the clutch CL as described later, and the rotor support member 30 configures a housing (clutch housing) that accommodates the clutch CL. According to the present example, the whole rotor support member 30 is utilized to configure the housing (clutch housing). In the description below, use of the term “rotor support member 30” encompasses the meaning of a “housing (clutch housing)” as well.

The intermediate shaft M is a shaft member used to input one or both of the torque of the internal combustion engine E through the clutch CL and the torque of the rotating electric machine MG to the speed change mechanism TM. The intermediate shaft M is spline-connected to the rotor support member 30. As shown in FIG. 2, the intermediate shaft M is provided as running through the second support wall 8. As described above, a radial center portion of the second support wall 8 is formed with the axial through hole, and the intermediate shaft M runs through the second support wall 8 via the through hole. The intermediate shaft M is supported in the radial direction as rotatable with respect to the second support wall 8. In the present embodiment, the intermediate shaft M has therein a plurality of oil passages that includes a supply oil passage 15 and a discharge oil passage 16. The supply oil passage 15 extends in the axial direction, and also extends in the radial direction at a predetermined position in the axial direction and opens to an outer peripheral surface of the intermediate shaft M so as to communicate with a hydraulic oil chamber H1 of the clutch CL. The discharge oil passage 16 extends in the axial direction, and opens to an end surface of the intermediate shaft M on the first axial direction A1 side.

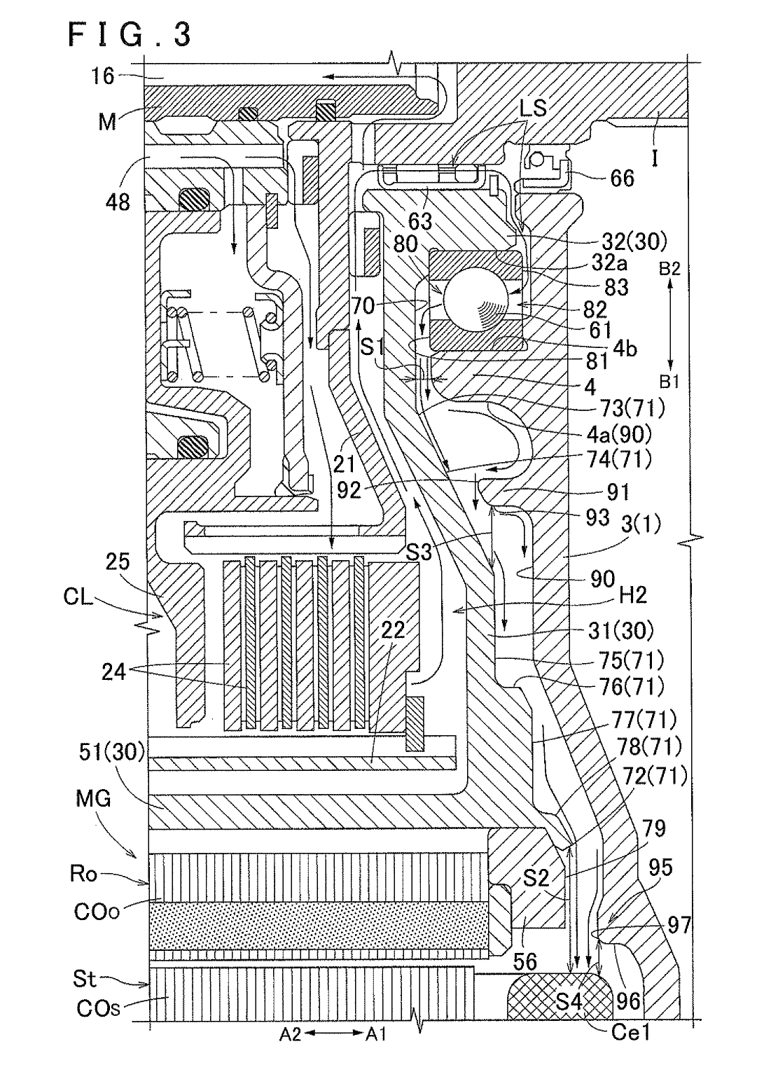

The clutch CL is a friction engagement device that is provided capable of switching between transmitting and not transmitting drive power between the input shaft I and the intermediate shaft M as described above, and selectively drive-couples with the internal combustion engine E and the rotating electric machine MG. In the present embodiment, the clutch CL is configured as a wet multi-disc clutch mechanism. As shown in FIG. 3, the clutch CL includes the clutch hub 21, a clutch drum 22, a plurality of friction plates 24, and a piston 25, The clutch hub 21 is connected to the input shaft I at the end portion of the input shaft I on the second axial direction A2 side so as to rotate together with the input shaft I. The clutch drum 22 is integratedly formed with the rotor support member 30, and connected to the intermediate shaft M through the rotor support member 30 so as to rotate together with the intermediate shaft M. The friction plates 24 are provided between the clutch hub 21 and the clutch drum 22, and include paired hub-side friction plates and drum-side friction plates.

In the present embodiment, the hydraulic oil chamber H1 is formed oil-tight between the piston 25 and the rotor support member 30 integrated with the clutch drum 22. The hydraulic oil chamber H1 is supplied, through the supply oil passage 15 formed in the intermediate shaft M, with pressurized oil that is discharged by the oil pump 18 and adjusted to a predetermined pressure by the hydraulic control device (not shown). The engagement and disengagement of the clutch CL is controlled through the oil pressure supplied to the hydraulic oil chamber H1. In addition, a circulation oil chamber H2 is formed on the opposite side of the piston 25 from the hydraulic oil chamber H1. The circulation oil chamber H2 is supplied, through a circulation oil passage 48 formed in the rotor support member 30, with pressurized oil that is discharged by the oil pump 18 and adjusted to a predetermined pressure by the hydraulic control device (not shown).

As shown in FIG. 2, the rotating electric machine MG is disposed on a radial outer side of the clutch CL. The rotating electric machine MG and the clutch CL are disposed at positions that overlap each other as viewed from the radial direction. Disposing the rotating electric machine MG and the clutch CL in such a positional relationship reduces the size of the overall system by shortening an axial length thereof.

The rotating electric motor MG includes the stator St that is fixed to the case 1, and the rotor Ro that is rotatably supported through the rotor support member 30 on a radial inner side of the stator St. The stator St and the rotor Ro are disposed in an opposed manner with a minute clearance therebetween in the radial direction. The stator St is configured as a laminated structure in which a plurality of flat, ring-shaped electromagnetic steel plates is laminated. The stator St includes a stator core COs that is fixed to the case 1, and a coil wound around the stator core COs. Note that a first coil end portion Ce1 is a section of the coil that protrudes toward the first axial direction A1 side from the stator core COs, and a second coil end portion Ce2 is a section of the coil that protrudes toward the second axial direction A2 side from the stator core COs. The rotor Ro of the rotating electric machine MG includes a rotor core COo that is configured as a laminated structure in which a plurality of flat, ring-shaped electromagnetic steel plates is laminated; and a permanent magnet embedded in the rotor core CO. In the present embodiment, a plurality of permanent magnets extending in the axial direction is arranged dispersed in the circumferential direction inside the rotor Ro (rotor core COo). The first coil end portion Ce1 in the present embodiment corresponds to a “coil end portion” of the present invention.

As shown in FIGS. 2 and 3, the hybrid drive system H according to the present embodiment includes the rotor support member 30 that supports the rotor Ro. The rotor support member 30 supports the rotor Ro as rotatable with respect to the case 1. More specifically, the rotor support member 30, with the rotor Ro fixed to an outer peripheral portion thereof, is supported by the first support wall 3 through a first bearing 61 on the first axial direction A1 side, and supported by the second support wall 8 through a second bearing 62 on the second axial direction A2 side. In addition, the rotor support member 30 is formed so as to cover the surrounding area of the clutch CL disposed therein, that is, the first axial direction A1 side, the second axial direction A2 side, and the radial outer side of the clutch CL. Therefore, the rotor support member 30 includes a first radial extension portion 31 that is disposed on the first axial direction A1 side of the clutch CL and extends in the radial direction; a second radial extension portion 41 that is disposed on the second axial direction A2 side of the clutch CL and extends in the radial direction; and an axial extension portion 51 that is disposed on the radial outer side of the clutch CL and extends in the axial direction.

The first radial extension portion 31 has a shape that at least extends in the radial direction; in the present embodiment, the first radial extension portion 31 extends in the radial direction and the circumferential direction. A radial center portion of the first radial extension portion 31 is formed with an axial through hole. The input shaft I inserted into the through hole runs through the first radial extension portion 31 and is inserted into the rotor support member 30. Further, in the present example, the first radial extension portion 31 is formed overall into a plate shape, and a shape in which a radial inner section thereof is offset so as to be positioned more toward the second axial direction A2 side than a radial outer section thereof.

The first radial extension portion 31 includes an axial protruding portion 32 with a cylindrical shape (boss shape) that protrudes toward the first axial direction A1 side. In the present embodiment, the axial protruding portion 32 is provided on a radial inner end portion of the first radial extension portion 31. The axial protruding portion 32 is formed so as to enclose the surrounding area of the input shaft I. A third bearing 63 is provided between the axial protruding portion 32 and the input shaft I. Here, the third bearing 63 is provided in contact with the outer peripheral surface of the input shaft I and an inner peripheral surface of the axial protruding portion 32. The first bearing 61 is provided between the axial protruding portion 4 of the first support wall 3 and the axial protruding portion 32. Here, the first bearing 61 is provided in contact with an outer peripheral surface 32a of the axial protruding portion 32 and an inner peripheral surface 4b of the axial protruding portion 4 of the first support wall 3. In the present example, a ball bearing is used as the first bearing 61 described above. The first bearing 61 and the third bearing 63 are disposed overlapping each other as viewed from the radial direction. Note that the first bearing 61 corresponds to a “rotor support bearing” of the present invention.

The second radial extension portion 41 has a shape that at least extends in the radial direction; in the present embodiment, the second radial extension portion 41 extends in the radial direction and the circumferential direction. A radial center portion of the second radial extension portion 41 is fanned with an axial through hole. The intermediate shaft M inserted into the through hole runs through the second radial extension portion 41 and is inserted into the rotor support member 30. Further, in the present example, the second radial extension portion 41 is formed overall into a plate shape. The second radial extension portion 41 is connected to an axial protruding portion 42 with a cylindrical shape (boss shape) that protrudes toward the second axial direction A2 side. The axial protruding portion 42 is integratedly connected to the second radial extension portion 41 on a radial inner end portion of the second radial extension portion 41. The axial protruding portion 42 is formed so as to enclose the surrounding area of the intermediate shaft M. Part of an inner peripheral surface of the axial protruding portion 42 in the axial direction is in contact with the outer peripheral surface of the intermediate shaft M over the entire circumferential direction. In addition, the second bearing 62 is provided between the axial protruding portion 9 of the second support wall 8 and the axial protruding portion 42. Here, the second bearing 62 is provided in contact with an outer peripheral surface of the axial protruding portion 42 and an inner peripheral surface of the axial protruding portion 9 of the second support wall 8. In the present example, a ball bearing is used as the second bearing 62 described above.

An inner peripheral surface of an end portion of the axial protruding portion 42 on the second axial direction A2 side is spline-connected to the intermediate shaft M such that the axial protruding portion 42 rotates together with the intermediate shaft M. An outer peripheral surface of the end portion of the axial protruding portion 42 on the second axial direction A2 side is spline-connected to the inner rotor that configures the oil pump 18 such that the axial protruding portion 42 rotates together with the inner rotor. Further, the hydraulic oil chamber H1 is formed between the second radial extension portion 41 and the piston 25.

In the present embodiment, the second radial extension portion 41 includes a cylindrical protruding portion 43 with a cylindrical shape that protrudes toward the second axial direction A2 side. According to the present example, the cylindrical protruding portion 43 is formed into a shape that has a certain degree of thickness in the axial direction and the radial direction. The cylindrical protruding portion 43 described above is formed in a radial outer area among the second radial extension portion 41. The cylindrical protruding portion 43 has a radial outer section overlapping with the rotor Ro as viewed from the axial direction. In addition, the cylindrical protruding portion 43 has a radial inner section overlapping with the clutch drum 22 as viewed from the axial direction. The cylindrical protruding portion 43 is also disposed overlapping with the second bearing 62 and the second coil end portion Ce2 as viewed from the radial direction.

An axial extension portion 51 has a shape that at least extends in the axial direction; in the present embodiment, the axial extension portion 51 extends in the axial direction and the circumferential direction. The axial extension portion 51 has a cylindrical shape that encircles the radial outer side of the clutch CL. The axial extension portion 51 is also connected to the first radial extension portion 31 and the second radial extension portion 41 in the axial direction at radial outer end portions thereof. In the present example, the axial extension portion 51 is integrally formed with the first radial extension portion 31 on the first axial direction A1 side. The axial extension portion 51 is connected to the second radial extension portion 41 on the second axial direction A2 side through a fastening member such as a bolt. It should be noted that a configuration that connects these through welding or the like is also acceptable. Moreover, the rotor Ro of the rotating electric machine MG is fixed to an outer peripheral portion of the axial extension portion 51.

In the present embodiment, the axial extension portion 51 includes an inner-side support portion 52 that has a cylindrical shape and extends in the axial direction; and a one-side support portion 53 that has a ring shape and extends radially outward from an end portion of the inner-side support portion 52 on the second axial direction A2 side. According to the present example, the one-side support portion 53 is formed into a shape that has a certain degree of thickness in the axial direction and the radial direction. The rotor Ro is in contact with and fixed to an outer peripheral surface of the inner-side support portion 52, whereby the inner-side support portion 52 supports the rotor Ro on its radial inner side. In addition, the rotor Ro is in contact with and fixed to an end surface of the one-side support portion 53 on the first axial direction A1 side, whereby the one-side support portion 53 supports the rotor Ro on its second axial direction A2 side. Note that a ring-shaped rotor holding member 56 is fitted over the inner-side support portion 52 from the first axial direction A1 side of the rotor Ro, and the rotor holding member 56 is disposed so as to contact the rotor Ro from the first axial direction A1 side and hold the rotor Ro from the first axial direction A1 side. In the present example, the rotor holding member 56 presses and holds the rotor Ro from the first axial direction A1 side with the plurality of electromagnetic steel plates clamped in the axial direction between the one-side support portion 53 and the rotor holding member 56.

As described above, the rotor support member 30 according to the present embodiment is configured to also function as the housing (clutch housing) that accommodates the clutch CL. The majority of the space formed inside the rotor support member 30 excluding the hydraulic oil chamber H1 corresponds to the circulation oil chamber H2 described earlier. In the present embodiment, the circulation oil chamber H2 is supplied through the circulation oil passage 48 with the oil that is discharged by the oil pump 18 and adjusted to a predetermined pressure. Here, according to the present embodiment, the third bearing 63 provided between the axial protruding portion 32 and the input shaft I is a bearing with a sealing function (in this case, a needle bearing with a seal ring) that is configured capable of securing a certain degree of fluid-tightness. Moreover, part of the inner peripheral surface of the axial protruding portion 42 of the second radial extension portion 41 in the axial direction is in contact with the outer peripheral surface of the intermediate shaft M over the entire circumferential direction. Therefore, the circulation oil chamber H2 inside the rotor support member 30 is fluid-tight, and the circulation oil chamber H2 is supplied with oil such that the circulation oil chamber H2 basically becomes filled with oil of a predetermined pressure or greater. Thus, in the hybrid drive system H according to the present embodiment, the plurality of friction plates 24 included in the clutch CL can be effectively cooled by the large amount of oil filling the circulation oil chamber H2. Note that the majority of the oil discharged from the circulation oil chamber H2 enters a radial through hole that opens to the outer peripheral surface of the input shaft I, after which the oil is discharged from the discharge oil passage 16 formed inside the intermediate shaft M and returns to the oil pan (not shown).

In the present embodiment, the rotation sensor 11 that detects the rotation angle of the rotor Ro is disposed (more specifically, adjacently disposed) on the second axial direction A2 side with respect to the rotor support member 30. Here, the rotation sensor 11 is provided between the second support wall 8 and the second radial extension portion 41 on the second axial direction A2 side of the rotor support member 30. The rotation sensor 11 is a sensor for detecting the rotation position of the rotor Ro with respect to the stator St of the rotating electric machine MG As the rotation sensor 11 described above, a resolver or the like may be used.

As shown in FIG. 2, a sensor rotor 12 is fixed to a side surface (of the cylindrical protruding portion 43) of the second radial extension portion 41 on the second axial direction A2 side in the present embodiment, and the sensor stator 13 is fixed to a side surface (of the axial protruding portion 9) of the second support wall 8 on the first axial direction A1 side.

According to this configuration, the rotation sensor is not disposed on the first axial direction A1 side of the rotor support member 30 on which an opposing extension surface portion 71 described later is formed. It is therefore possible to prevent the rotation sensor 11 from interfering with a flow of oil that flows on the opposing extension surface portion 71, and a smooth oil flow can be achieved.

### 1-3. Bearing Lubrication Structure

Next, a bearing lubrication structure according to the present embodiment will be described with reference to FIGS. 2 and 3. In the present embodiment, as shown in FIG. 2, the second bearing 62 has a structure that is directly lubricated by some of the oil from the oil pump 18 and bypasses the hydraulic control device (not shown). That is, according to the present embodiment, some of the oil inside the pump chamber that accommodates the oil pump 18 slowly and gradually leaks in the axial direction by passing through a minute clearance between the inner peripheral surface of the through hole of the second support wall 8 and the outer peripheral surface of the axial protruding portion 42 of the second radial extension portion 41 so as to lubricate the second bearing 62, which is disposed next to the minute clearance on the first axial direction A1 side. The oil that lubricated the second bearing 62 is then supplied for cooling to the second coil end portion Ce2 disposed on a radial outer side of the second bearing 62, and the like.

Meanwhile, as shown in FIG. 3, the first bearing 61 and the third bearing 63 have structures that are lubricated by some of the oil discharged from the circulation oil chamber H2 after being supplied to the fluid-tight circulation oil chamber H2 through the hydraulic control device (not shown). That is, according to the present embodiment, some of the oil discharged from the circulation oil chamber H2 lubricates the third bearing 63 provided between the outer peripheral surface of the input shaft I and the inner peripheral surface of the axial protruding portion 32, after which the oil passes through the third bearing 63 and leaks out toward the first axial direction A1 side. The oil leaking out from the third bearing 63 is blocked by the seal member 66 provided between the outer peripheral surface of the input shaft I and the inner peripheral surface of the through hole of the first support wall 3 on the first axial direction A1 side of the third bearing 63, and instead flows radially outward so as to lubricate the first bearing 61 disposed on the radial outer side of the third bearing 63. Thus, in the present embodiment, a lubrication oil supply passage LS is provided as a minute clearance between the rotor support member 30 (axial protruding portion 32) and the input shaft (more precisely, between the axial protruding portion 32 and parts configuring the third bearing 63, and between the input shaft I and parts configuring the third bearing 63). In the first bearing 61, a supplied portion 82 that is supplied with the oil of the lubrication oil supply passage LS is included on a supply-side surface 83, which is a surface of the first bearing 61 on the first axial direction A1 side. Accordingly, the oil from the lubrication oil supply passage LS is supplied to the first bearing 61 from a radial outer side and first axial direction A1 side of the first bearing 61. Thus, the present embodiment can utilize some of the oil discharged from the fluid-tight circulation oil chamber H2 to lubricate the third bearing 63 and also the first bearing 61, which is disposed more radially outward than the axial protruding portion 32. The lubrication oil supply passage LS in the present embodiment corresponds to a “supply portion” of the present invention.

In the first bearing 61, a discharge portion 80 that discharges the oil supplied from the lubrication oil supply passage LS is included on a discharge-side surface 81, which is a surface of the first bearing 61 on the second axial direction A2 side. Accordingly, the oil that lubricated the first bearing 61 is discharged to the second axial direction A2 side of the first bearing 61.

As described in detail below, the oil discharged from the first bearing 61 flows along the opposing extension surface portion 71 toward the first axial direction A1 side and radially outward, and is supplied to the first coil end portion Ce1 that extends from the stator core COs toward the first axial direction A1 side to cool the first coil end portion Ce1.

### 1-3-1. Oil Supply Utilizing Side Surface of Rotor Support Member 30

As shown in FIG. 3, the rotor support member 30 (first radial extension portion 31) includes an opposing surface portion 70 that is more toward the second axial direction A2 side than the discharge-side surface 81 of the first bearing 61, and opposes the discharge-side surface 81; and the opposing extension surface portion 71 that extends radially outward from the opposing surface portion 70. Here, the opposing surface portion 70 is a surface portion disposed at a position that is more toward the second axial direction A2 side than the discharge-side surface 81, and overlaps with the discharge-side surface 81 as viewed from the axial direction. In addition, the opposing surface portion 70 is disposed with an axial space S1 interposed between the opposing surface portion 70 and the discharge-side surface 81.

A radial outer end portion 72 of the opposing extension surface portion 71 is disposed at a position that is more radially inward than the first coil end portion Ce1, and overlaps with the first coil end portion Ce1 as viewed from the radial direction. In addition, the radial outer end portion 72 is disposed with a radial space S2 interposed between the radial outer end portion 72 and the first coil end portion Ce1.

The opposing extension surface portion 71 is formed such that a radial cross section from a radial inner end portion 73 to the radial outer end portion 72 of the opposing extension surface portion 71 extends only in one or both of a direction heading radially outward and a direction heading toward the first axial direction A1 side. Note that “radial cross section” refers to a cross section obtained by cutting along a plane that includes the rotation shaft center of the rotating electric machine MG as shown in FIG. 3.

The discharge-side surface 81 of the first bearing 61 is disposed more toward the second axial direction A2 side than the radial outer end portion 72 of the opposing extension surface portion 71. More specifically, the discharge-side surface 81 is disposed at a position overlapping with the stator core COs as viewed from the radial direction. According to this configuration, the first bearing 61 is disposed so as to at least partially overlap with the stator core COs and the rotor core COo as viewed from the radial direction. Thus, a space more radially inward than the rotor Ro can be effectively utilized to dispose the first bearing 61, and the axial length of the hybrid drive system H can be easily shortened.

According to the present embodiment, the radial cross section from the radial inner end portion 73 to the radial outer end portion 72 of the opposing extension surface portion 71 is formed from a plurality of surface portions, and formed so as to head in a stepped manner toward the first axial direction A1 side as the radial cross section extends radially outward.

In other words, the radial cross section is generally configured from a first inclined surface portion 74 that extends only in one or both of a direction heading radially outward from the radial inner end portion 73 and a direction heading toward the first axial direction A1 side; a first radial extending surface portion 75 that extends only from a radial outer end portion of the first inclined surface portion 74 in a direction heading radially outward; an axial extending surface portion 76 that extends only in a direction heading toward the first axial direction A1 side from a radial outer end portion of the first radial extending surface portion 75; a second radial extending surface portion 77 that extends only in a direction heading radially outward from an end portion of the axial extending surface portion 76 on the first axial direction A1 side; and a second inclined surface portion 78 that extends only in both of a direction heading radially outward from a radial outer end portion of the second radial extending surface portion 77 to the radial outer end portion 72 of the opposing extension surface portion 71 and a direction heading toward the first axial direction A1 side. Here, the second inclined surface portion 78 is a surface of a fixing portion on the first axial direction A1 side that supports the rotor core COo from the first axial direction A1 side. In the present example, the second inclined surface portion 78 is configured from two inclined surfaces with different inclination angles, and a curved surface that links the two inclined surfaces. Note that a short inclined surface is provided between the axial extending surface portion 76 and the second radial extending surface portion 77. In addition, connecting sections of the surface portions are linked by smooth curved surfaces or chamfering. Further note that the first inclined surface portion 74 and the second inclined surface portion 78 are formed so as to head more toward the first axial direction A1 side as they extend radially outward. The first inclined surface portion 74 in the present embodiment corresponds to an “inclined surface portion” of the present invention. Also, in the present embodiment, the opposing surface portion 70 is a surface portion that extends only in the radial direction and the circumferential direction. The space S1 between the opposing surface portion 70 and the discharge-side surface 81 is narrower than an opening width of the discharge portion 80 of the first bearing 61. That is, the flow of the oil discharged from the first bearing 61 is reduced in the space S1. Thus, the oil discharged from the discharge portion 80 comes into contact with the opposing surface portion 70 and flows along the opposing surface portion 70.

According to the configuration described above, the oil discharged from the discharge portion 80 of the first bearing 61 is supplied to the opposing surface portion 70 of the rotor support member 30, which is disposed facing the discharge-side surface 81. The rotor support member 30 rotates during operation of the drive system, and therefore the oil supplied to the opposing surface portion 70 of the rotor support member 30 is subjected to the centrifugal force heading radially outward, whereby the oil flows from the opposing surface portion 70 toward the opposing extension surface portion 71 that extends radially outward.

In this case, since the opposing extension surface portion 71 is formed such that the radial cross section from the radial inner end portion 73 to the radial outer end portion 72 extends only in one or both of a direction heading radially outward and a direction heading toward the first axial direction A1 side, the opposing extension surface portion 71 is formed so as to extend overall between the radial inner end portion 73 and the radial outer end portion 72 toward one or both of radially inward and toward the first axial direction A1 side. Thus, a force (force vector) heading radially outward that is caused by centrifugal force and acts on the oil is broken down on the opposing extension surface portion 71 into one or both of a component heading toward the opposing extension surface portion 71 (heading toward a direction opposite the normal direction of the radial outer end portion 72), and a component heading radially outward (toward the radial outer end portion 72) along the opposing extension surface portion 71. Accordingly, the oil on the opposing extension surface portion 71 does not separate from the opposing extension surface portion 71, and flows radially outward (to the radial outer end portion 72) along the opposing extension surface portion 71. In addition, even if the discharge-side surface 81 is disposed at a position overlapping with the stator core COs as viewed from the radial direction as described above, the radial cross section from the radial inner end portion 73 to the radial outer end portion 72 of the opposing extension surface portion 71 is formed so as to extend only in one or both of a direction heading radially outward and a direction heading toward the first axial direction A1 side, Therefore, the oil discharged from the discharge-side surface 81 can appropriately flow radially outward and toward the first axial direction A1 side, and be supplied to the first coil end portion Ce1 that extends from the stator core COs toward the first axial direction A1 side.

The oil that flows to the radial outer end portion 72 of the opposing extension surface portion 71 separates from the radial outer end portion 72 and scatters radially outward due to the centrifugal force heading radially outward. In this case, the first coil end portion Ce1 is disposed with the space S2 interposed between the first coil end portion Ce1 and the radial outer end portion 72 in a direction heading radially outward from the radial outer end portion 72. Therefore, the oil scattered radially outward from the radial outer end portion 72 is supplied to the first coil end portion Ce1. At such time, because the rotor support member 30 is rotating, the oil that flows radially outward along the opposing extension surface portion 71 is supplied over the entire circumference of the first coil end portion Ce1.

According to the configuration described above, the discharge-side surface 81 of the first bearing 61 is disposed more toward the second axial direction A2 side than the radial outer end portion 72 of the opposing extension surface portion 71. In addition, the opposing extension surface portion 71 is formed such that the radial cross section thereof from the opposing surface portion 70 disposed on the second axial direction A2 side of the discharge-side surface 81 to the radial outer end portion 72 extends in one or both of a direction heading radially outward and a direction heading toward the first axial direction A1 side. Thus, the opposing extension surface portion 71 is disposed in a direction heading radially outward from the discharge-side surface 81 of the first bearing 61. In the present embodiment, the rotation shaft center is horizontally disposed, and therefore includes a direction heading downward B1 among the directions heading radially outward. Accordingly, the opposing extension surface portion 71 is disposed in a direction heading downward B1 from the discharge-side surface 81 of the first bearing 61.

Therefore, the oil flowing downward B1 along the discharge-side surface 81 due to gravity among the oil discharged from the discharge portion 80 of the first bearing 61 is supplied in a dripping manner or flows to the opposing surface portion 71 disposed downward B1 of the discharge-side surface 81. Also, because the opposing extension surface portion 71 is rotating, the oil that flows downward B1 from the discharge-side surface 81 of the first bearing 61 is supplied over the entire circumference of the opposing extension surface portion 71. Therefore, the center of gravity of the rotor Ro can be prevented from becoming eccentric due to the mass of the oil supplied to the opposing extension surface portion 71.

As described above, the oil supplied to the opposing extension surface portion 71 then flows along the opposing extension surface portion 71 to the radial outer end portion 72 due to the centrifugal force heading radially outward, and is supplied over the entire circumference of the first coil end portion Ce1 from the radial outer end portion 72.

Accordingly, the oil discharged from the discharge portion 80 of the first bearing 61 flows along the opposing extension surface portion 71 to the radial outer end portion 72 and is supplied over the entire circumference of the first coil end portion Ce1 from the radial outer end portion 72. Therefore, the entire circumference of the first coil end portion Ce1 can be cooled.

As described above, the opposing extension surface portion 71 is formed such that the radial cross section from the radial inner end portion 73 to the radial outer end portion 72 extends only in one or both of a direction heading radially outward and a direction heading toward the first axial direction A1 side. In addition, the first coil end portion Ce1 exists in a direction heading radially outward from the radial outer end portion 72, with the space S2 interposed between the radial outer end portion 72 and the first coil end portion Ce1. Thus, the radial outer end portion 72 is a section that is positioned most toward the first axial direction A1 side among the opposing extension surface portion 71, which extends radially outward from the opposing surface portion 70. Accordingly, the radial outer end portion 72 of the opposing extension surface portion 71 can also be defined as a section that is positioned most toward the first axial direction A1 side among the surfaces of the rotor support member 30 on the first axial direction A1 side, which extend radially outward from the opposing surface portion 70.

As a consequence, more radially outward than the radial outer end portion 72, the opposing extension surface portion 71 has no surface that extends more toward the first axial direction A1 side than the radial outer end portion 72. Therefore, the opposing extension surface portion 71 does not face radially inward and toward the first axial direction A1 side on the radial outer side of the radial outer end portion 72; instead, the opposing extension surface portion 71 faces radially outward and toward the first axial direction A1 side. Thus, a force (force vector) heading radially outward that is caused by centrifugal force and acts on the oil on the radial outer end portion 72 does not break down into a component heading toward the opposing extension surface portion 71 on the radial outer end portion 72, and the centrifugal force instead acts unchanged on the oil. Accordingly, the oil on the radial outer end portion 72 separates from the radial outer end portion 72 and scatters radially outward due to the centrifugal force heading radially outward. Note that, in the rotational speed region of the rotor Ro during normal operation of the rotating electric machine MG, the centrifugal force acting on the oil on the radial outer end portion 72 sufficiently increases as the oil is scattered radially outward. As described above, the first coil end portion Ce1 is disposed with the space S2 interposed between the first coil end portion Ce1 and the radial outer end portion 72 in a direction heading radially outward from the radial outer end portion 72. Therefore, the oil scattered radially outward from the radial outer end portion 72 is then supplied to the first coil end portion Ce1.

The present embodiment, as shown in FIG. 3, includes the rotor holding member 56 radially outward and on the second axial direction A2 side with respect to the radial outer end portion 72, and as a separate member from the rotor support member 30. The rotor holding member 56 is a cylindrical member for supporting the rotor core COo from the first axial direction A1 side, and the rotor holding member 56 is axially supported from the first axial direction A1 side by the fixing portion of the rotor support member 30.

A side surface 79 of the rotor holding member 56 on the first axial direction A1 side is disposed radially outward and on the second axial direction A2 side with respect to the radial outer end portion 72 of the rotor support member 30. Thus, the oil scattered radially outward from the radial outer end portion 72 of the rotor support member 30 due to centrifugal force passes more toward the first axial direction A1 side than the side surface 79 of the rotor holding member 56 on the first axial direction A1 side.

It should be noted that the first coil end portion Ce1 is disposed in a direction heading radially outward from a radial outer end portion of the side surface 79 of the rotor holding member 56 on the first axial direction A1 side, with a space interposed between the first coil end portion Ce1 and the radial outer end portion. The oil scattered radially outward from the radial outer end portion 72 of the rotor support member 30 may adhere to the side surface 79 of the rotor holding member 56 on the first axial direction A1 side due to a disturbance or the like in the scattering direction. But even in such case, the adhered oil is scattered and supplied to the first coil end portion Ce1 from the radial outer end portion of the side surface 79 by centrifugal force. Moreover, some of the oil that flows to the radial outer end portion 72 of the rotor support member 30 may not scatter radially outward from the radial outer end portion 72 for reasons such as a large amount of oil, a low rotational speed of the rotor Ro, or a small centrifugal force, and instead flow to a side surface of the rotor holding member 56 on the first axial direction A1 side. But even in such case, the oil is supplied to the first coil end portion Ce1 from the radial outer end portion of the side surface 79 of the rotor holding member 56 by centrifugal force.

### 1-3-2. Oil Supply Utilizing Side Surface of First Support Wall 3

### 1-3-2-1. Oil Supply Utilizing Projection Portion 91

The first support wall 3 includes a support wall surface portion 90 that is more toward the first axial direction A1 side than the opposing extension surface portion 71, faces the opposing extension surface portion 71, and extends in the radial direction.

The support wall surface portion 90 includes a projection portion 91 that is more downward B1 than the discharge portion 80, protrudes toward the second axial direction A2 side, and extends in a direction intersecting the vertical direction along the support wall surface portion 90.

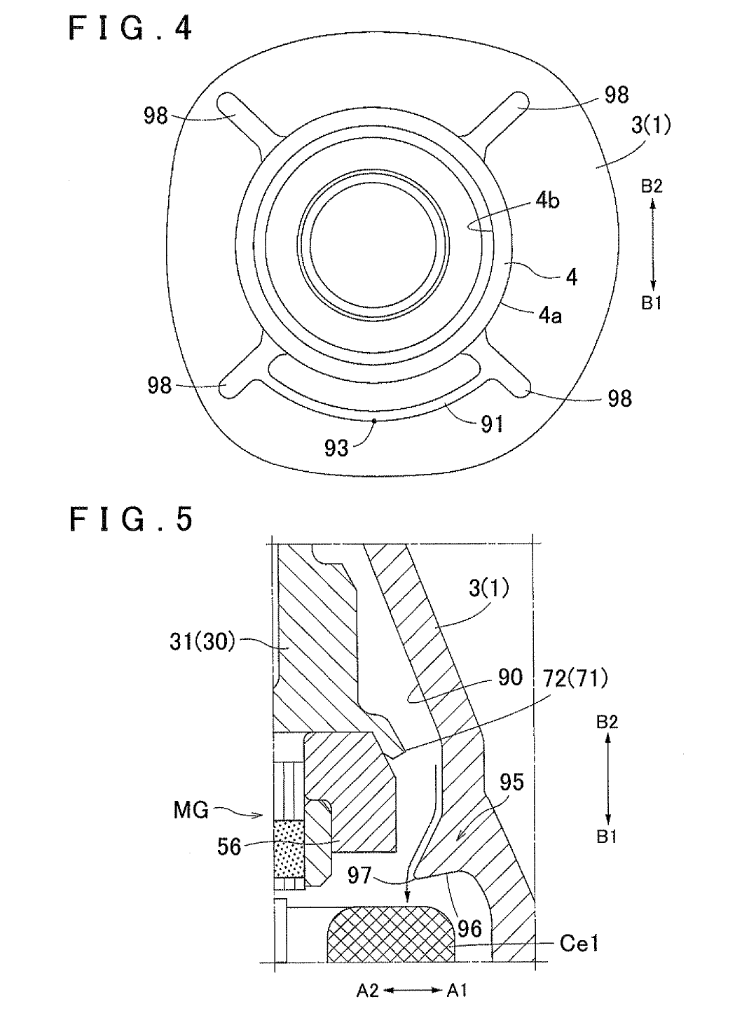

Part of the opposing surface portion 71 is disposed at a position that is downward B1 of a lowermost portion 93 of an end portion 92 of the projection portion 91 on the second axial direction A2 side, and overlaps with the lowermost portion 93 as viewed from the vertical direction. The lowermost portion 93 is disposed with a vertical space S3 interposed between the lowermost portion 93 and that part of the opposing extension surface portion 71. Here, as shown in FIG. 4, the lowermost portion 93 of the end portion 92 on the second axial direction A2 side is a section that is most downward B1 among the end portion 92 of the projection portion 91 on the second axial direction A2 side that extends in a direction intersecting the vertical direction (a direction heading downward B1 or upward B2). Note that FIG. 4 is a plane view of a radially inward section of the first support wall 3 (support wall surface portion 90) as viewed from the axial direction heading from the second axial direction A2 side toward the first axial direction A1 side. Further note that the vertical direction (direction heading downward B1 or upward B2) in FIGS. 2 to 5 represents a direction of the hybrid drive system H when the vehicle mounted with the hybrid drive system H runs on a horizontal plane, and the rotation shaft center of the rotating electric machine MG is horizontally disposed.

As shown in FIG. 4, the projection portion 91 is formed so as to extend over an entire area overlapping with the discharge portion 80 as viewed from upward B2. It should be noted that “overlapping” in this case represents a positional relationship in a direction perpendicular to both the axial direction and the vertical direction (horizontal direction within a plane perpendicular to the axial direction). That is, according to the positional relationship in the horizontal direction described above, the projection portion 91 is formed so as to extend over an entire area overlapping with the discharge portion 80. Here, the first bearing 61 (discharge portion 80) is disposed radially inward of the axial protruding portion 4. In other words, the projection portion 91 is disposed in all directions heading downward B1 from each section of the discharge portion 80. Thus, the oil that flows downward B1 from each section of the discharge portion 80 along the support wall surface portion 90 can be reliably blocked by the projection portion 91 and flow toward the opposing extension surface portion 71 of the rotor support member 30.

In the present embodiment, as shown in FIG. 4, the projection portion 91 is formed so as to extend in the circumferential direction over an entire area overlapping with the discharge portion 80 as viewed from upward B2. More specifically, the projection portion 91 has an arc configuration that is concentric with the first bearing 61. Accordingly, the lowermost portion 93 of the projection portion 91 is positioned on an axis that extends downward B1 from the center (axial center) of the first bearing 61 (discharge portion 80). In addition, the projection portion 91 has the same protruding height toward the second axial direction A2 side throughout the circumferential direction. Thus, the opposing extension surface portion 71 is disposed in all directions heading downward B1 from each circumferential part of the end portion 92 of the projection portion 91 on the second axial direction A2 side, with a space interposed between the opposing extension surface portion 71 and the end portion 92. Therefore, even when the oil drips downward B1 from the end portion 92 of the projection portion 91 other than the lowermost portion 93, the oil can be supplied to the opposing extension surface portion 71.

Therefore, the oil flowing downward B1 along the discharge-side surface 81 due to gravity among the oil discharged from the discharge portion 80 of the first bearing 61 is divided, as described above, into a portion that drips down to the opposing extension surface portion 71 disposed downward B1 of the discharge-side surface 81, and a portion that flows downward B1 along the support wall surface portion 90 that extends radially outward from the first bearing 61.

The oil flowing downward B1 along the support wall surface portion 90 from the discharge portion 80 is blocked from flowing further downward B1 by the projection portion 91, which is disposed downward B1 of the discharge portion 80 and protrudes toward the second axial direction A2 side. In addition, the projection portion 91 extends in a direction intersecting the vertical direction along the support wall surface portion 90, and therefore, an upward B2 side of the projection portion 91 is formed with an upper surface that extends in a direction intersecting the vertical direction along the support wall surface portion 90 and extends in the second axial direction A2. This upper surface of the projection portion 91 can effectively block the flow of oil from the discharge portion 80 downward B1 along the support wall surface portion 90. Further, the upper surface of the projection portion 91 can receive and temporarily accumulate the oil.

The oil on the upper surface of the projection portion 91, due to gravity, flows in the second axial direction A2 and flows toward a lowermost portion of the upper surface. The oil flowing to the end portion 92 of the projection portion 91 on the second axial direction A2 side flows toward the lowermost portion 93 along the end portion 92 due to gravity and surface tension. The oil flowing to the lowermost portion 93 of the end portion 92 then drips from the lowermost portion 93 downward B1 due to gravity. According to the configuration described above, the opposing extension surface portion 71 of the rotor support member 30 is disposed in a direction heading downward B1 from the lowermost portion 93, with the space S3 interposed between the opposing extension surface portion 71 and the lowermost portion 93. Thus, the oil dripping downward B1 from the lowermost portion 93 of the projection portion 91 is supplied to the opposing extension surface portion 71.

Also, because the opposing extension surface portion 71 is rotating as mentioned above, the oil that drips downward B1 from the lowermost portion 93 of the projection portion 91 is supplied over the entire circumference of the opposing extension surface portion 71. As described above, the oil supplied to the opposing extension surface portion 71 then flows along the opposing extension surface portion 71 to the radial outer end portion 72 due to the centrifugal force heading radially outward, and is supplied over the entire circumference of the first coil end portion Ce1 from the radial outer end portion 72.

According to the present embodiment, part of the first inclined surface portion 74 is disposed at a position that is downward B1 of the lowermost portion 93 of the end portion 92 of the projection portion 91 on the second axial direction A2 side, and overlaps with the lowermost portion 93 as viewed from the vertical direction. In addition, the lowermost portion 93 is disposed with the vertical space S3 interposed between the lowermost portion 93 and part of the first inclined surface portion 74.

Thus, the present embodiment is configured such that the oil dripping downward B1 from the lowermost portion 93 of the projection portion 91 is supplied to the first inclined surface portion 74 of the opposing extension surface portion 71. A force (force vector) heading radially outward that is caused by centrifugal force and acts on the oil on the first inclined surface portion 74 is broken down on the first inclined surface portion 74 facing radially inward and toward the first axial direction A1 side, as described above, into a component heading toward the first inclined surface portion 74, and a component heading radially outward along the first inclined surface portion 74. Accordingly, the supplied oil on the opposing extension surface portion 71 starts to flow radially outward immediately after being supplied, and smoothly flows to the radial outer end portion 72 without accumulating on the opposing extension surface portion 71.

Further, in the present embodiment, the lowermost portion 93 of the projection portion 91 is disposed upward B2 of the first inclined surface portion 74 (more specifically, near an axial center portion thereof). Therefore, even if the rotation shaft center of the rotating electric machine MG is inclined with respect to the horizontal direction, the first inclined surface portion 74 can be positioned in a direction heading downward from the lowermost portion 93 of the projection portion 91.

In the present embodiment, the oil blocked by the projection portion 91 gathers at the lowermost portion 93 and increases in flow, and because the space S3 between the lowermost portion 93 of the projection portion 91 and the opposing extension surface portion 71 is narrow, the oil flowing along the lowermost portion 93 is reduced in flow in the space S3. Thus, the oil flowing along the lowermost portion 93 comes into contact with the opposing extension surface portion 71 and can flow along the opposing extension surface portion 71.

According to the present embodiment, the support wall surface portion 90 includes a radial extending projection portion 98 that protrudes toward the second axial direction A2 side, and extends radially outward by a predetermined width from part of an outer peripheral surface 4a of the axial protruding portion 4 (four locations in FIG. 4). A protruding width of the radial extending projection portion 98 toward the second axial direction A2 side is formed so as to progressively decrease radially outward, as shown in FIG. 2.

### 1-3-2-2. Oil Supply Utilizing Stepped Portion 95

As shown in FIGS. 2 and 3, the support wall surface portion 90 includes a stepped portion 95 that has a stepped surface 96 facing radially outward. An end portion 97 of the stepped surface 96 on the second axial direction A2 side is disposed at a position that is more radially inward than the first coil end portion Ce1, and overlaps with the first coil end portion Ce1 as viewed from the radial direction. In addition, the end portion 97 is disposed with a radial space S4 interposed between the end portion 97 and the first coil end portion Ce1.

Some of the oil flowing downward of the end portion 92 of the projection portion 91 on the axial second direction A2 side does not drip downward onto the opposing extension surface portion 71 and instead flows downward along the support wall surface portion 90 due to surface tension. The oil not blocked by the projection portion 91 among the oil discharged from the discharge portion 80 may alternatively flow downward along the support wall surface portion 90. The oil scattered radially outward from the radial outer end portion 72 of the opposing extension surface portion 71 may alternatively adhere to the support wall surface portion 90 due to a disturbance or the like in the scattering direction. But even in such case, the adhered oil flows downward along the support wall surface portion 90. Thus, the oil not supplied to the opposing extension surface portion 71 flows downward along the support wall surface portion 90.

The oil flowing downward along the support wall surface portion 90 then reaches a section among the stepped portion 95 that is positioned more toward the downward B1 side than the discharge portion 80. Such oil drips downward from the end portion 97 of the stepped surface 96 on the second axial direction A2 side due to gravity.

The first coil end portion Ce1 is disposed in a direction heading radially outward from the end portion 97 of the stepped surface 96 on the second axial direction A2 side, with the space S4 interposed between the first coil end portion Ce1 and the end portion 97. In the present embodiment, the rotation shaft center of the rotating electric machine MG is horizontally disposed. Therefore, the first coil end portion Ce1 is disposed in a direction heading downward B1 from each part of the end portion 97 positioned more toward the downward B1 side than the discharge portion 80, with a space interposed between the first coil end portion Ce1 and the end portion 97. Thus, the oil dripping from the end portion 97 of the stepped surface 96 is supplied to the first coil end portion Ce1. More specifically, the oil along the support wall surface portion 90 that reaches the stepped portion 95 (the end portion 97 of the stepped surface 96) flows along the end portion 97 of the stepped surface 96 to the lowermost portion of the end portion 97 due to gravity and surface tension. The oil reaching the lowermost portion of the end portion 97 then drips downward from the lowermost portion and is supplied to the first coil end portion Ce1. Note that the lowermost portion of the end portion 97 is positioned on an axis that extends downward B1 from the center of the discharge portion 80.

Accordingly, the oil not supplied to the opposing extension surface portion 71 is also supplied to the first coil end portion Ce1 by the stepped portion 95, and can be utilized to cool the first coil end portion Ce1.

The stepped surface 96 is a surface parallel to the axial direction or a surface that extends more radially inward as the stepped surface 96 extends toward the first axial direction A1 side. In the present embodiment, the stepped surface 96 is a surface parallel to the axial direction as shown in FIGS. 2 and 3.

A force (force vector) heading downward B1 that is caused by gravity and acts on the oil on the stepped surface 96 does not break down on the stepped surface 96 into a component heading toward the first axial direction A1 side. Therefore, it is possible to suppress the flow of oil along the stepped surface 96 toward the first axial direction A1 side. Accordingly, the oil can drip from the end portion 97 of the stepped surface 96 on the second axial direction A2 side.

In the present embodiment, the stepped portion 95 is formed over the entire circumference. The end portion 97 on each part of the stepped surface 96 on the second axial direction A2 side is disposed at a position that is more radially inward than the first coil end portion Ce1, and overlaps with the first coil end portion Ce1 as viewed from the radial direction. In addition, the end portion 97 is disposed with the radial space S4 interposed between the end portion 97 and the first coil end portion Ce1.

### 2. Other Embodiments

Other embodiments of the vehicle drive system according to the present invention will be described now. Note that the characteristic configurations disclosed in the respective embodiments below are not limited to those particular embodiments, and may also be applied in combination with the characteristic configurations disclosed in other embodiments unless an inconsistency occurs.

(1) According to the embodiment described above, as an example, the radial cross section from the radial inner end portion 73 to the radial outer end portion 72 of the opposing extension surface portion 71 is formed from a plurality of surface portions, and formed so as to head in a stepped manner toward the first axial direction A1 side as the radial cross section extends radially outward. However, the embodiments of the present invention are not limited to this example. That is, the radial cross section from the radial inner end portion 73 to the radial outer end portion 72 of the opposing extension surface portion 71 may have any configuration provided that the radial cross section is formed so as to extend only in one or both of a direction heading radially outward and a direction heading toward the first axial direction A1 side. For example, the radial cross section may be configured from only an inclined surface that extends in both of a direction heading radially outward and a direction heading toward the first axial direction A1 side. Alternatively, the radial cross section may not include the inclined surface portion, and may have a stepped configuration that combines a radial extending surface portion that extends only in a direction heading radially outward and an axial extending surface portion that extends only in a direction heading toward the first axial direction A1 side.

(2) In the embodiment described above, as an example, the radial outer end portion 72 of the opposing extension surface portion 71 is a section that is most radially outward among the surfaces of the rotor support member 30 on the first axial direction A1 side. However, the embodiments of the present invention are not limited to this example. That is, a surface of the rotor support member 30 on the first axial direction A1 side may be further provided radially outward of the radial outer end portion 72 of the opposing extension surface portion 71. However, a section of the rotor support member 30 more radially outward than the radial outer end portion 72 is positioned on the second axial direction A2 side with respect to the radial outer end portion 72. Thus, the oil that flows radially outward along the opposing extension surface portion 71 can be scattered toward the first coil end portion Ce1 from the radial outer end portion 72.

(3) In the embodiment described above, as an example, part of the first inclined surface portion 74 is disposed at a position that is downward B1 of the lowermost portion 93 of the end portion 92 on the second axial direction A2 side of the projection portion 91, and overlaps with the lowermost portion 93 as viewed from the vertical direction. However, the embodiments of the present invention are not limited to this example. That is, part of the opposing extension surface portion 71 other than the first inclined surface portion 74 (e.g., part of the axial extending surface portion 76 or part of the second inclined surface portion 78) may be disposed at a position that is downward B1 of the lowermost portion 93 of the end portion 92 on the second axial direction A2 side of the projection portion 91, and overlaps with the lowermost portion 93 as viewed from the vertical direction. In this case as well, the lowermost portion 93 must be disposed with the vertical space S3 interposed between the lowermost portion 93 and that particular part of the opposing extension surface portion 71.

(4) In the embodiment described above, as an example, the projection portion 91 is formed so as to extend in the circumferential direction over an entire area overlapping with the discharge portion 80 as viewed from upward B2. However, the embodiments of the present invention are not limited to this example. That is, the projection portion 91 may have any configuration provided that the projection portion 91 is formed so as to include a section that protrudes from the support wall surface portion 90 toward the second axial direction A2 side, and also formed so as to extend in a direction that has a directional component intersecting the vertical direction along the support wall surface portion 90. For example, the projection portion 91 may be formed more radially outward than the discharge portion 80 so as to protrude from the support wall surface portion 90 toward the second axial direction A2 side, and extend over the entire circumference around the discharge portion 80. As another example, the projection portion 91 may be formed so as to protrude from the support wall surface portion 90 toward the second axial direction A2 side downward B1 of the discharge portion 80, and linearly extend in the horizontal direction or at an angle with respect to the horizontal direction as viewed from the axial direction. As yet another example, the projection portion 91 may be formed in an arc configuration or the like that recesses upward as viewed from the axial direction.

These cases are also acceptable so long as part of the opposing surface portion 71 is disposed at a position that is downward B1 of the lowermost portion 93 of the end portion 92 of the projection portion 91 on the second axial direction A2 side, and overlaps with the lowermost portion 93 as viewed from the vertical direction, with the lowermost portion 93 disposed with the vertical space S3 interposed between the lowermost portion 93 and the opposing extension surface portion 71.

(5) In the embodiment described above, as an example, the stepped surface 96 is a surface parallel to the axial direction. However, the embodiments of the present invention are not limited to this example. That is, provided that the stepped surface 96 is a surface facing radially outward, the stepped surface 96 may include, as shown in FIG. 5, a surface that extends more radially inward as the stepped surface 96 extends toward the first axial direction A1 side. In this case as well, a force (force vector) heading downward. B1 that is caused by gravity and acts on the oil on the stepped surface 96 breaks down on the stepped surface 96 into a component heading toward the second axial direction A2 side. Therefore, it is possible to greatly suppress the flow of oil along the stepped surface 96 toward the first axial direction A1 side. Accordingly, the oil can effectively drip from the end portion 97 of the stepped surface 96 on the second axial direction A2 side.

(6) In the embodiment described above, as an example, the stepped portion 95 is formed over the entire circumference. However, the embodiments of the present invention are not limited to this example. That is, the stepped portion 95 may be disposed only more toward the downward B1 side than the discharge portion 80. Moreover, the stepped portion 95 may be disposed only in a direction heading downward B1 from the discharge portion 80, i.e., disposed only in an area overlapping with the discharge portion 80 as viewed from vertically upward. The stepped portion 95 may also be formed so as to linearly extend in the horizontal direction or at an angle with respect to the horizontal direction as viewed from the axial direction, or formed in an arc configuration or the like that recesses upward as viewed from the axial direction.

(7) In the embodiment described above, as an example, the rotation shaft center of the rotating electric machine MG is horizontally disposed. However, the embodiments of the present invention are not limited to this example. That is, the rotation shaft center of the rotating electric machine MG may be disposed at a nearly horizontal angle (e.g., an angle equal to or less than 45 degrees with respect to horizontal).

(8) In the embodiment described above, as an example, the hybrid drive system H has a multiple axis configuration suitable for mounting in a front engine, front wheel drive (FF) vehicle. However, the embodiments of the present invention are not limited to this example. That is, in the hybrid drive system H that has a single axis configuration according to another preferred embodiment of the present invention, the output shaft of the speed change mechanism TM may be disposed coaxial with the input shaft I and the intermediate shaft M, and directly drive-coupled to the output differential gear device DF. The hybrid drive system H having the configuration described above is suitable for mounting in a front engine, rear wheel drive (FR) vehicle, for example.

(9) In the embodiments described above, as an example, the vehicle drive system according to the present invention is applied to the hybrid drive system H for a hybrid vehicle that includes both of the internal combustion engine E and the rotating electric machine MG as drive power sources of the vehicle. However, the embodiments of the present invention are not limited to this example. That is, the present invention may be applied to a drive system for an electric vehicle (electrically powered vehicle) that includes only the rotating electric machine MG as the drive power source of the vehicle.

The present invention is well suited for use as a vehicle drive system that includes, as a drive power source of the vehicle, a rotating electric machine that has a rotor and a stator.

What is claimed is:

1. A vehicle drive system comprising:
a rotating electric machine, as a drive power source of a vehicle, that includes a rotor and a stator;
a case that accommodates the rotating electric machine, and includes an at least radially extending support wall on a first axial direction side, the first axial direction side being one axial direction side with respect to the rotating electric machine;
a rotor support member that is more radially inward than the stator and supports the rotor;
a rotor support bearing that supports the rotor support member as rotatable with respect to the support wall; and
a supply portion that supplies oil to the rotor support bearing, wherein
a side opposite from the first axial direction side in the axial direction is a second axial direction side,
the rotor support bearing includes, on a discharge-side surface that is a surface of the rotor support bearing on the second axial direction side, a discharge portion that discharges the oil supplied from the supply portion,
the rotor support member includes an opposing surface portion that is more toward the second axial direction side than the discharge-side surface and opposes the discharge-side surface, and an opposing extension surface portion that extends radially outward from the opposing surface portion,
the stator includes a stator core, and a coil end portion that protrudes from the stator core toward the first axial direction side,
a radial outer end portion of the opposing extension surface portion is disposed at a position that is more radially inward than the coil end portion, and overlaps with the coil end portion as viewed from the radial direction, with a radial space interposed between the radial outer end portion and the coil end portion,
the discharge-side surface is disposed more toward the second axial direction side than the radial outer end portion of the opposing extension surface portion, and
the opposing extension surface portion is formed such that a radial cross section from a radial inner end portion of the opposing extension surface portion to the radial outer end portion extends only in one or both of a direction heading radially outward and a direction heading toward the first axial direction side.

2. The vehicle drive system according to claim 1, wherein
the support wall includes a support wall surface portion that is more toward the first axial direction side than the opposing extension surface portion, faces the opposing extension surface portion, and extends in the radial direction,
the support wall surface portion includes a projection portion that is more downward than the discharge portion, protrudes toward the second axial direction side, and extends in a direction intersecting the vertical direction along the support wall surface portion, and
a portion of the opposing surface portion is disposed at a position that is downward of a lowermost portion of an end portion of the projection portion on the second axial direction side, and overlaps with the lowermost portion as viewed from the vertical direction, and the lowermost portion is disposed with a vertical space interposed between the lowermost portion and the portion of the opposing extension surface portion.

3. The vehicle drive system according to claim 2, wherein
the projection portion is formed so as to extend over an entire area overlapping with the discharge portion based on a positional relationship in a direction perpendicular to both the axial direction and the vertical direction.

4. The vehicle drive system according to claim 2, wherein
the opposing extension surface portion includes an inclined surface portion that extends more toward the first axial direction side as the inclined surface portion extends radially outward,
a portion of the inclined surface portion is disposed at a position that is downward of the lowermost portion of the end portion of the projection portion on the second axial direction side, and overlaps with the lowermost portion as viewed from the vertical direction, and the lowermost portion is disposed with a vertical space interposed between the lowermost portion and the portion of the inclined surface portion.

5. The vehicle drive system according to claim 1, wherein
the support wall includes a support wall surface portion that is more toward the first axial direction side than the opposing extension surface portion, faces the opposing extension surface portion, and extends in the radial direction,
the support wall surface portion includes a stepped portion that has a stepped surface facing radially outward, and
an end portion of the stepped surface on the second axial direction side is disposed at a position that is more radially inward than the coil end portion, and overlaps with the coil end portion as viewed from the radial direction, with a radial space interposed between the end portion and the coil end portion.

6. The vehicle drive system according to claim 5, wherein
the stepped surface is one of a surface parallel to the axial direction, and a surface that extends more radially inward as the surface extends toward the first axial direction side.

7. The vehicle drive system according to claim 1, wherein
the discharge-side surface is disposed at a position overlapping with the stator core as viewed from the radial direction.

8. The vehicle drive system according to claim 1, further comprising:
a rotation sensor that detects the rotation of the rotor, wherein
the rotation sensor is disposed at a position on the second axial direction side with respect to the rotor support member.
